(19) United States
(12) Patent Application Publication
(10) Pub. No.: US 2020/0009936 A1
(43) Pub. Date: Jan. 9, 2020

(54) SUSPENSION DEVICE

(71) Applicant: HYDAC SYSTEMS & SERVICES GMBH, Sulzbach/Saar (DE)

(72) Inventor: Heinz-Peter HUTH, Ueberherrn (DE)

(21) Appl. No.: 16/486,881

(22) PCT Filed: Feb. 7, 2018
(86) PCT No.: PCT/EP2018/053106

§ 371 Date: Aug. 19, 2019

(30) Foreign Application Priority Data
Feb. 21, 2017 (DE) 10 2017 001 653.4

(51) Int. Cl. B60G 17/056; B60G 11/30; B60G 11/26

(52) U.S. Cl. CPC B60G 17/0565; B60G 11/30; B60G 11/265; B60G 2202/414; B60G 2300/082; B60G 2500/302; B60G 2202/154

(57) ABSTRACT

A suspension device, in particular for axle suspensions in tractors, having at least one suspension cylinder, the piston rod unit (12) of which separates a piston side (18) from an annular side (14) in a cylinder housing (20), is characterized in that a pressure relief valve (26) is used to limit a maximum pressure at the annular side (14) of the relevant suspension cylinder.

The invention relates to a suspension device, in particular for axle suspensions in tractors, having at least one suspension cylinder whose piston rod unit separates a piston side from an annular side in a cylinder housing.

WO 2006/021327 A1 discloses a suspension device, in particular for vehicles, in which load conditions change, having
at least one suspension cylinder, each having pressure chambers, such as an annular space as an annular side and a piston chamber as a piston side,
a load-sensing system for pressure generation,
two main branches forming supply lines between these spaces and a pump and a tank connection, wherein a valve is present in every main branch, of which at least one valve is a pressure control valve, which is used to adjust the pressure of the relevant predeterminable pressure chamber of the relevant suspension cylinder, and
a leveling system, wherein
In addition to the pressure adjustment, the automatic leveling is performed by means of this pressure regulating valve, and
the pressure control valve is electrically actuated by means of a control device for this purpose.

According to this solution the prior art, the pressure on the annular side can be set to different pressure levels, to implement different suspension characteristics in this way, in doing so, the assumption is made that the load is arranged on the piston side and the wheel sets including the wheel axles are arranged on the rod side of the respective suspension cylinders. As a result the pressure on the piston side is determined by the load and the pressure in the annular space. The position of the proportional pressure control valve, which may also be a proportional pressure reducing valve, is not limited to the rod side of the suspension cylinder, but rather the position is determined by the pressure chamber, on which the load is not directly applied.

From EP 1419 910 A3 a hydropneumatic suspension is also known, having at least one suspension cylinder and at least one suspension accumulator, in particular hydraulic accumulator, and having an actuated valve, in particular proportional valve, for opening or blocking a fluid'conveying connection between the suspension cylinder and the suspension as accumulator. Because in the known solution the controllable, in particular pilot operated, valve can be brought into the closed position by a hydraulic control device, any electrical actuation solutions are completely avoided and the pilot operated valve for switching on and off of the relevant suspension accumulator hydropneumatic suspension on the piston side is exclusively hydraulically actuated in a safe manner. As stated, axle suspensions, especially in tractors, operate according to the known principle pressurization on the annular side to reduce the pressure ratio on the piston side in comparison to the load ratio. By applying a variable pressure on the annular side the allowable load ratio can be increased and/or different spring characteristics can be generated (adaptive axle suspension).

Based on the prior art indicated above, the invention addresses the problem of providing a proportional pressure adjustment on the annular side of a suspension cylinder for an axle suspension, which is reliable in operation and, having few components, can be implemented inexpensively.

A suspension device having the features of claim 1 in its entirety solves this problem.

Because according to the characterizing part of patent claim 1, the pressure on the annular side of the individual suspension cylinder is limited to a maximum pressure value by means of a pressure relief valve, a proportional pressure adjustment in the desired way on the annular side of the respective suspension cylinders of the suspension device or of the axle suspension can easily be implemented in a functionally reliable and cost-effective manner by means of this pressure relief valve.

In a particularly preferred embodiment of the suspension device according to the invention, the pressure relief valve is an inversely proportional pressure relief valve, which limits the maximum pressure on the annular side of the individual suspension cylinder in the de-energized state, and in the energized state, it adjusts the pressure to be limited on the annular side of the suspension cylinder in an infinitely variable way.

The inverse proportional pressure relief valve has excellent control characteristics and provides stability for the relevant suspension cylinder for the entire volume flow range. A correspondingly optimized flow geometry results in low pressure losses at high response dynamics and the valve can be adjusted accordingly over the entire range of the volume flow. Because the preset highest pressure is present in the de-energized state of the valve, a fail-safe function has been implemented. In the de-energized state, the inverse proportional pressure relief valve limits the pressure to maximum pressure settings and thus has the function as the maximum pressure limit for the annular side of the relevant suspension cylinder. During operation and thus when the pressure setting changes, said valve is actuated to the desired pressure in an electro-proportional manner and optionally oil is supplied to or removed from the annular side by means of an additionally provided valve device, such that the pressure at the annular side can be set to the desired value.

In a particularly preferred embodiment provision is made that a leveling system is connected to the piston side of the relevant suspension cylinder. The leveling system particularly preferably has two electro-magnetically operable valves, of which preferably a 3/2-way valve is used for lifting and a 2/2-way valve, preferably connected between the 3/2-way valve and the piston side of the suspension cylinder, is used for lowering the relevant suspension cylinder.

The leveling system mentioned results in a system, which can be used to raise or lower the associated vehicle in the form of a working machine, such as a tractor, or keep its height constant. In this way, the vehicle level can be kept constant for different loading conditions, regardless of changing load conditions. In this way, the optimum ground clearance and a horizontal position of the motor vehicle can be achieved in any operating condition. Such a lifting of the vehicle also permits driving over obstacles, or lowering the vehicle while driving underneath obstacles. The solution of a suspension device according to the invention ensures that regardless of the set level for the axle suspension of the vehicle, the proportional pressure adjustment on the annular side of the respective suspension cylinders can still be performed to achieve an adaptive axle suspension based on a variable pressure on the annular side. This is without parallel in the prior art.

In a further, particularly preferred embodiment of the suspension device according to the invention, provision is made that, starting from the pressure supply upstream of the inverse proportional pressure relief valve and the annulus or rod side of the relevant suspension cylinder, a diaphragm or throttle is installed in the supply line. The pertinent aperture or throttle can also be implemented by a nozzle and is generally used to limit the total flow in this area.

Further advantageous embodiments of the suspension device according to the invention are the subject of the other dependent claims.

The suspension device according to the invention will now be described in greater detail by way of two exemplary embodiments shown in the drawing. In the figures, in the form of a general view, not to scale, of hydraulic diagrams,

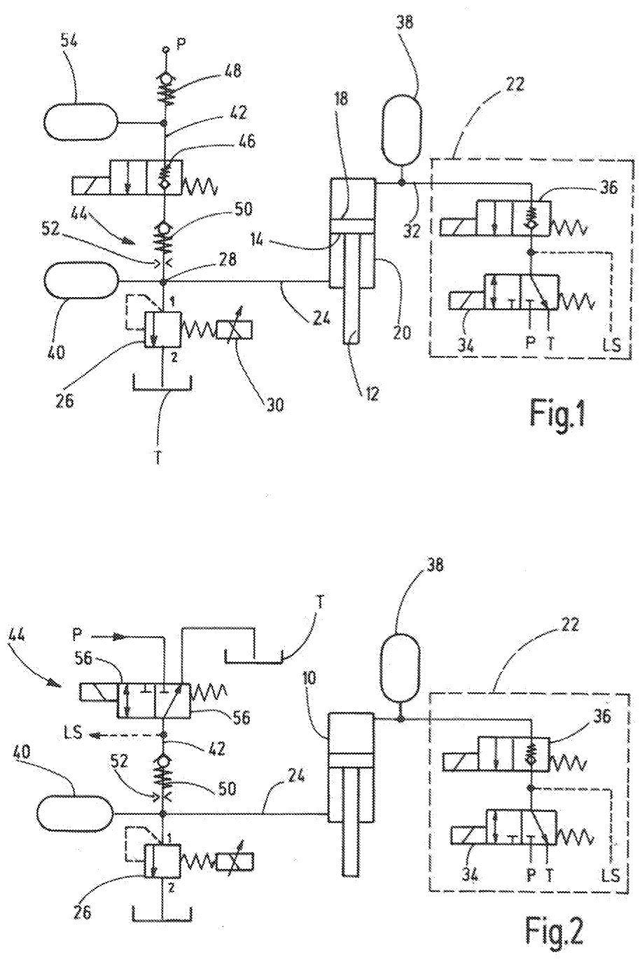

FIG. 1 shows the major components of a first embodiment of the suspension device according to the invention;

FIG. 2 shows a second, further embodiment comparable to the illustration of FIG. 1.

FIG. 1 shows the major functional components of a first embodiment of the suspension device in the manner of a hydraulic circuit diagram. The suspension device is particularly suitable for axle suspensions in machines such as tractors; but it can easily generally be used for all types of agricultural machinery, construction machinery and special vehicles. In FIG. 1, only one suspension cylinder 10 is shown by way of example; however, it is self-evident that several such suspension cylinders are used for a reliable axle suspension, two suspension cylinders preferably being provided for one axle of the machine. The piston-rod unit 12 of the relevant suspension cylinder 10 can be attached at both its annular or rod side 14 and its piston side 18, including the relevant cylinder housing 20, to a wheelset or the like.

Viewed in the direction of FIG. 1 the proportional pressure setting for the annular side 14 of the suspension cylinder to is shown on the left of the suspension cylinder and on the right side, its leveling system is shown as a block 22, which leveling system is optional; i.e. it is not required for the proportional pressure adjustment as such.

A pressure relief valve 26 in the form of a so-called, inverse proportional pressure relief valve is connected to the annular side 14 of the suspension cylinder 10, via a connecting line 24. The valve, hereinafter referred to only as pressure relief valve 26 for short, is at its port 2 connected to a tank T on the outlet side in a fluid-discharging manner and at the input side via its port 1 to an intersection 28, into which the connecting line 24 also opens.

If the pressure at the port 1 of the valve 26 rises above the set value, the main piston (not shown) of the valve opens and oil flows in the direction of the tank-side port 2. Depending on the electrical setpoint, predetermined by the electro-magnetic control device 30 of the valve 26, the pressure to be limited at the annular side 14 of the relevant suspension cylinder 10 can be controlled in an infinitely variable way. The valve 26 is, as already stated, inversely controlled, i.e. at a if the control current is reduced, the valve 26 is passage opening of the valve is reduced and a counter pressure is generated at the port 1. In the de-energized state, the highest, preset pressure is applied to the valve 26, which permits the implementation of a so-called fail-safe function. The maximum pressure can be preset in such valves in this respect.

A directly controlled, inverse proportional pressure relief valve 26 in spool design and in the manner of a screw-in valve can be obtained from the patentee under the order no. PDBM06020Z.

The leveling system 22 is connected to the piston side 18 of the relevant suspension cylinder 10, via a further connecting line 32. The leveling system 22 has two electro-magnetically actuated valves 34,36, of which the valve 34 is designed as a 3/2-way valve and used to lift the suspension cylinder and the other valve 36 is designed as a 2/2-way valve and is used to lower the relevant suspension cylinder 10. The pertinent composition of a leveling system 22 is shown in the prior art, i.e. it will not be discussed in detail at this point. A load-sensing line LS opens between the two valves 34,36. Further, at its input side the valve 34 is connected to a pressure supply P and to the tank T. Further, a hydraulic accumulator 38 of conventional design is installed between the leveling system 22 and the suspension cylinder 10 in the further connecting line 32, which hydraulic accumulator determines the damping characteristic on the piston side 18 of the suspension cylinder 10. The damping characteristic on the annular side 14 of the suspension cylinder 10 is predetermined by a further hydraulic accumulator 40 of conventional design, the fluid side of which is connected to the intersection 28.

Viewed in the direction of FIG. 1, a supply line 42 connected to the intersection 28 is present above the intersection 28 and, as part of a valve device 44, an electro-magnetically actuated 2/2-way valve 46 is installed in the line 42, which valve in the illustrated not actuated state separates the pressure supply P, which is connected to the supply line 42, from the annular side 14 of the suspension cylinder 10. In the actuated state of the valve 46, the pertinent fluid supply is released, in which case the two check valves 48 and 50 installed in the supply line 42 open accordingly.

The pressure P can be supplied via a conventional pressure source, such as a constant-hydraulic pump or the like. The discharged pressure can correlate with the maximum pressure of the hydraulic pump. A diaphragm or throttle 52 is also installed between the lower check valve 50 and the intersection 28, which is used to limit the flow of the overall system, in particular in the form of the suspension cylinder 10. A further hydraulic accumulator 54 of conventional design is also installed between the upper check valve 48 and the valve 46, which accumulator can ensure the supply of fluid to the supply line 42 for a predetermined period of time if the pressure supply P is insufficient.

Based on the arrangement shown, a proportional pressure adjustment on the annular side 14 of the relevant suspension cylinder 10 is achieved independently of the level specification of the leveling system 22. When de-energized, the proportional pressure relief valve 26 limits the pressure to the maximum permissible pressure setting and thus serves as a fail-safe device of the maximum pressure limit on the annular side 14 of the suspension cylinder 10. In action, i.e. if a change in the pressure setting and/or the leveling system is desired, the valve 26 is electro-proportionally actuated to the desired pressure and the valves 34 of the leveling system 22 can be used to supply or remove oil to set or regulate the pressure on the annular side to the desired value. If the leveling system 22 is omitted, the fluid for the annular side 14 of the relevant suspension cylinder 10 can only be supplied via the pressure supply P via the supply line 42. It is self-evident that a corresponding sensor system must be present for a function actuation of the overall system, which detects, for instance, the position of the suspension cylinder 10 and/or determines the individual pressure values in the system. Depending on the travel and/or pressure situation, the relevant valves are then actuated via a higher-level machine or vehicle control. As pertinent control systems and sensor technology are commonplace in practice, further details of these are not discussed.

Below, a modified embodiment of the suspension device according to the invention is explained in more detail based on FIG. 2, wherein the same components, as described so far, are also provided with the same reference numerals. In that regard, the statements made so far also apply to the modified embodiment of FIG. 2.

The embodiment of FIG. 2 differs from the solution according to FIG. 1, in that a 3/2-way valve 56 is installed in the pressure supply of the annular side 14 of the relevant suspension cylinder to instead of the 2/2-way valve 46 of FIG. 1, which 3/2-way valve blocks the pressure supply P in the shown, non-actuated or non-activated state and otherwise depressurizes a further load-sensing line LS, which opens into the supply line 42 between the valve 56 and check valve 50, towards the tank side T. In the actuated state of the valve, the connection to the tank T is blocked and the pressure supply P is connected to the supply line 42 in a pressure-supplying manner. Otherwise, the functional sequence for the solution according to FIG. 2 is exactly as described above for the first embodiment.

Both solutions can be used to increase permissible load conditions by a variable pressure on the annular side 14 of the suspension cylinder 10 and/or to produce different spring characteristics in the sense of an adaptive axle suspension. This is without parallel in the prior art.

1. A suspension device, in particular for axle suspensions in tractors, having at least one suspension cylinder (10), the piston rod unit (12) of which separates a piston side (18) from an annular side (14) in a cylinder housing (20), characterized in that a pressure relief valve (26) is used to limit a maximum pressure at the annular side (14) of the relevant suspension cylinder (10).

2. The suspension device according to claim 1, characterized in that the pressure relief valve (26) is an inverse proportional pressure relief valve, which limits the maximum pressure on the annular side (14) of the individual suspension cylinder (10) in the de-energized state and in the energized state, it adjusts the pressure to be limited on the annular side (14) in an infinitely variable way.

3. The suspension device according to claim 1, characterized in that a leveling system (22) is installed on the piston side (18) of the relevant suspension cylinder (10).

4. The suspension device according to claim 1, characterized in that the leveling system (22) has two electromagnetically actuated valves (34, 36), of which preferably a 3/2-way valve (34) is used to lift and a 2/2-way valve (36), preferably installed between the 3/2-way valve (34) and the piston side (18), is used to lower the relevant suspension cylinder (10).

5. The suspension device according to claim 1, characterized in that the lifting valve (34) is connected to a pressure supply port (P) and a tank port (T) on the input side and that a load-sensing line (LS) is connected between the outlet of the lifting valve and the inlet of the port of the lowering valve.

6. The suspension device according to claim 1, characterized in that the leveling system (22) is permanently connected to the individually assignable piston side (18) of the suspension cylinder (10) in a fluid-conveying manner preferably with the interposition of at least one hydraulic accumulator (38).

7. The suspension device according to claim 1, characterized in that on the input side the pressure relief valve (26) is permanently connected to the annular side (14) of the individually assignable suspension cylinder (10) and to a pressure supply (P), which can be switched on and off by means of a valve device (44).

8. The suspension device according to claim 1, characterized in that at least one check valve (48, 50), which opens in the direction of the pressure relief valve (26), and preferably at least one hydraulic accumulator (40, 54) are installed between the pressure supply (P) and the pressure relief valve (26) in the supply line (42) of the pressure relief valve (26).

9. The suspension device according to claim 1, characterized in that at least one load-sensing line (LS) opens into the supply line (42) between the valve device (44), which preferably has at least one electro-magnetically controllable 2/2 or 3/2-way valve (46; 56) and a non-return valve (50) downstream thereof.

10. The suspension device according to claim 1, characterized in that a diaphragm (52) or throttle is installed in the supply line (42) between a check valve (50), to which the pressure relief valve (26) connects, and this pressure relief valve (26).
